(19) United States
(12) Patent Application Publication
(10) Pub. No.: US 2005/0146443 A1
(43) Pub. Date: Jul. 7, 2005

(54) Accelerator operational indicating device to reinforce the safety for automobiles

(76) Inventor: Wei-Sheng Chen, Feng-Yuan City (TW)

Correspondence Address: WEI-SHENG CHEN, P.O. Box 697, Feng-Yuan City, Taichung Hsien, 420, TW

(21) Appl. No.: 10/745,579

(22) Filed: Dec. 29, 2003

(51) Int. Cl. G08B 5/22

(52) U.S. Cl. 340/815.45; 340/467; 340/464; 340/479

(57) ABSTRACT

An accelerator operational indicating device to reinforce the safety for automobiles includes a detector having one end connected to a treadle of the accelerator through a pair of first electric wires and a second end connected to a controller through a pair of second electric wires. The controller is embedded into an indicator which is disposed at a predetermined position on the back of an automobile and has a plurality of LED lamps spacedly disposed on outer surface and connected to the controller which transmits the signals from the detector in accordance with the vertical movement of the treadle to sequentially lighten or put out the LED lamps in order to warn the driver in a followed automobile to take appropriate action to avoid an accident of car crash.

### BACKGROUND OF THE INVENTION

The present invention relates to bumping-proof device for automobiles and more particularly to an accelerator operational indicating device to reinforce the safety for automobiles which has the lamp signals to indicate the treading condition of the accelerator in order to prevent the front and the rear cars from unexpectedly collision.

According to the relevant surveying informations, the most traffic accident is caused due to the following cars to hit the front cars. The reason is that the driver of a rear car could not know the driving condition of a front car. So that he knows the driving condition only by means of watching the indicator of the brake light or the side-marker light of the front car. But he couldn't know whether or not the driver of the front car is treading the accelerator or the treading extent or that the driver is releasing the accelerator or tightening the accelerator. During the running hours especially those running at high speed, if the rear car is followed too close to the front car, the driver of the rear car is always too late to tread his own brake after he becomes aware of the lightening of the brake light of the front car. An accident of crash may therefore be caused within few second. On the contrary, if the driver of the rear car can know the entire driving conditions of the front car by watching the using condition of the accelerator of the front car such as whether or not the accelerator of the front car is being treaded down and the treading extent or the accelerator is being released and/or the accelerator is being tightened. He can timely adjust his own driving manner to avoid an accident of crash to be happened. So far, there is no any device to indicate the operational condition of the accelerator in a running car. Although, there is the safety air bag and the seat belts installed in most of the modern cars, but they are only functioned at the critical moment and could not rely upon as a previously preventive arrangement.

### SUMMARY OF THE PRESENT INVENTION

The present invention has a main object to provide an accelerator operational indicating device to reinforce the safety for automobiles by which, the driver of the following car can distinguish the operational condition of the accelerator of the front car in order to decide to accelerate or to slow down his own car to avoid a collision.

Another object of the present invention is to provide an accelerator operational indicating device to reinforce the safety for automobiles in which a plurality of indicator lamps disposed at an appropriate position on the back of a car. The driver of a following car can immediately distinguished the operational condition of the accelerator in a front car by watching the lightening conditions of the indicator lamps.

Further object of the present invention is to provide an accelerator operational indicating device to reinforce the safety for automobiles in which the indicator lamps can be combined with the brake indicator lamps or separated from the brake indicator lamps and/or adapt a set of double color indicator lamps to indicate both the brake and the accelerator operational conditions.

Accordingly, the accelerator operational indicating device of the present invention comprises generally a detector, a set of indicator lamps and a controller.

The detector is functioned to detect the operational condition of the accelerator.

The controller is functioned to transmit a signal to the indicator after receiving the information from the detector, while the indicator lamps provide different lightening appearances to warn the driver of a followed car to change the speed of his own car in order to obtain a previous prevention of an accident.

The present invention will become more fully understood by reference to the following detailed description thereof when read in conjunction with the attached drawings.

### BRIEF DESCRIPTION OF THE DRAWINGS

FIG. 1 is a chart to indicate the structural principles of the accelerator operational indicating device of the present invention,

FIG. 2 is a diagram to describe the function of the detector,

FIG. 3 is a diagram of an electric circuit of the controller,

FIG. 4 is a diagram to show a tubular foot used in the device of the present invention,

FIG. 5 is a diagram to show a collective pith plate instead of the electric circuit of the controller in FIG. 3,

FIG. 6 is a diagram of an electric circuit of the present invention,

FIG. 7 is a perspective view to show the structure of the present invention,

FIG. 8 is a plane view of the detector,

FIG. 9 is a plane view of the linking-up movable contact point in action, and

FIG. 10 is a plane view to show that the indicator lamps lightened sequentially.

### DETAILED DESCRIPTION OF THE PREFERRED EMBODIMENT

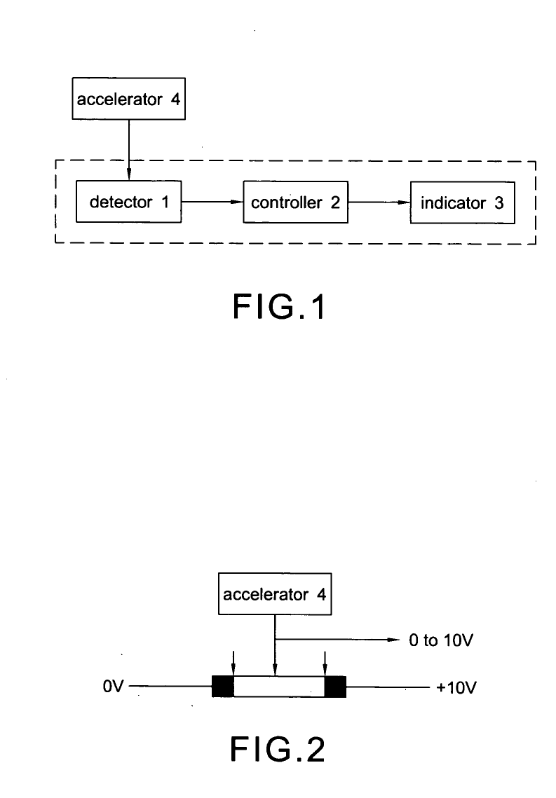

With reference to FIG. 1 of the drawings, the accelerator operational indicating device to reinforce the safety of automobiles of the present invention comprises a detector 1, a controller 2 and indicator 3 including a plurality of indicator lamps sequentially connected with each other wherein further has an accelerator 4 connects to the detector 1 which detects the operational information of the accelerator 4. The information includes that the accelerator 4 whether or not is being treaded down, the extent of the downward movement as well as the tendency of the immediate variations of the accelerator 4.

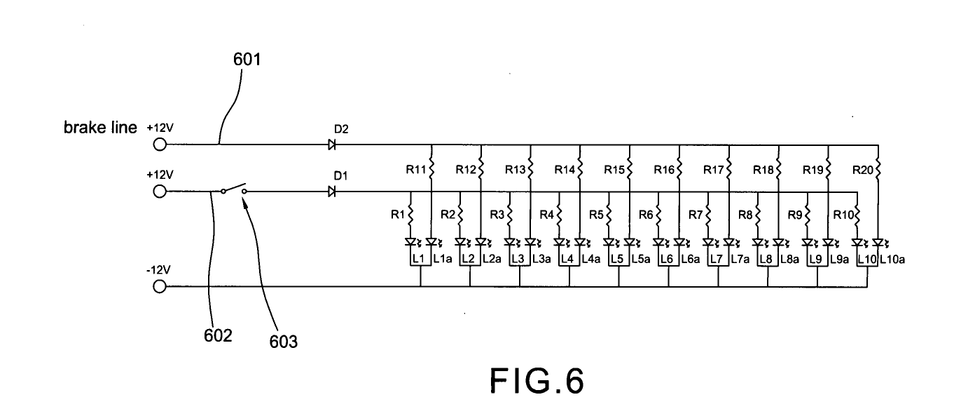

Referring to FIG. 6, the indicator 3 may adapt one set of simultaneously lightened and putting out indicator lamp or a number of indicator lamps. In the diagram, the L1 to L10 represent the indicator lamps, L1a to L10a represent the brake indicator lamps and the R1 to R20 are functioned to lower down the voltage, wherein the brake indicator lamps may be combined together with the accelerator indicator lamps. When the accelerator 4 is treaded down, all of the 10 indicator lamps are lightened due to that the switch 603 of the detector is turned on. But the switch 603 will be automatically turned off and the 10 indicator lamps are immediately put out if the accelerator 4 is released. Meanwhile, the detector 1 can be designed into a switch type or a button type for solely detecting whether or not the accelerator 4 is treaded down. For instance, it can adopt the same structure used in the brake system. When the accelerator 4 is treaded down, the electric current is connected to the indicator lamps and if the accelerator 4 is not treaded down, the electric current is disconnected to the indicator lamps. FIG. 6 shows the brake indicator lamps L1a to L10a are accurated by the electric wire 601 and the electric wire 602 through the detector switch 603 to supply the electric current to the accelerator indicator lamps L1 to L10.

Because a single indicator lamp can not indicate the varied movement of the accelerator 4. Thus, there must be more then two indicator lamps in the indicator 3. For instance 10 LED lamps or a single lamp contains several LED. When the accelerator 4 is not being treaded, all of the LED lamps are in put out state. If the accelerator 4 is being slightly treaded, the first LED lamp is lightened. Then the second, the third and all of the 10 LTD lamps are lightened in accordance with the gradually downward movement of the accelerator 4 and the gradually intensified the signals from the detector 1. On the contrary, if the accelerator 4 is gradually released, the 10 LED lamps will be sequentially put out.

If adopts 10 sets of LED lamps, it can be arranged into a straight line and lighten or put on there LED lamps in accordance with the right order. The LED lamps can be of course arranged as a curved shape, a circular shape, a rectangular shape and/or a triangular shape. Besides, if each set of LED lamps includes 7 LED which are capable of to align an Arabic numeral such that the LED in the first lamp may be formed into “1”, the LED in the second lamp may be formed into “2”, etc., Therefore, the numerals can be sequentially indicating the operational situations of the accelerator 4. Further, the LED may be replaced with other lamps or any appropriate luminous means.

FIG. 2 shows that the detector 1 is of a variable resistor which has a movable contact point linking-up with the accelerator 4. Concretely, one end of the contact point is linking-up with a treadle of the accelerator 4 or a dragging wire of the accelerator 4 and the other end thereof slides about in the resistor. When the treadle is remained at its original position, the contact point is at a leftmost position and the inputted voltage is of 0V. But the inputted voltage becomes greater and greater in concert with the right movement of the contact point. So that the inputted voltage at middle portion is of 5V and becomes 10V at the rightmost position. Therefore, the ascendant and/or the descendant of the voltage can reflect the variable tendency of the movement of the treadle. This detector 1 may also adapt an infrared ray sensor or a magnetic sensor, or a voltameter and/or a pressure sensor, conclusively, any relevant component parts of the prior art which can be able to transform the varied treadle movement into the signals of voltage and/or the electric current are suitable to make a detector 1 of the present invention.

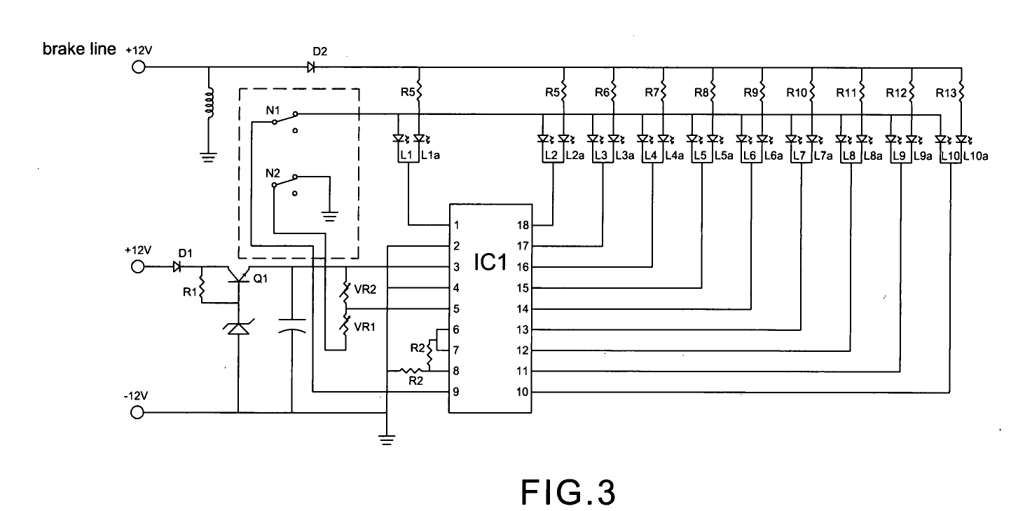

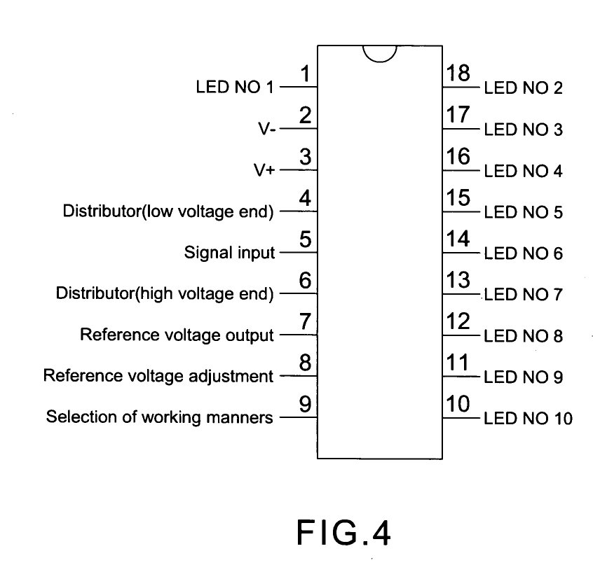

The controller 2 of the present invention is functioned to transform the voltage value and the electric current value big or small into different circuit control signals and the voltage signal inputted from the above discussed variable resistor detector 1 is transformed into different circuit control signals either. FIG. 3 shows in this embodiment that the accelerator 4 indicator lamps L1 to L10 are combined with the brake indicator lamps L1a to L10a, wherein the 10 LED lamps L1a to L10a indicate the different movements of the brake. While the brake is treaded down, the uppermost +12V current is connected, so as to lighten all the indicator lamps L1a to L10a. If there is no voltage inputted from the uppermost +12V current wire because it receives no brake movement signal, thus all the indicator lamps L1a to L10a are put out. Farther, D1 and D2 are provided to protect the whole system and prevent the components from damaged due to the reverse connection of the wires. R2 and R3 is provided to establish the reference voltages. Wherein the ten LED lamps of L1 to L10 are functioned to indicate the treading condition of the treadle. Each set of the ten LED lamps has only one LED. The IC may adopts LM3914 and its tubular foot is shown in FIG. 4. FIG. 3 also shows that VR2 is functioned to adjust the extent of the range for VR1 which is functioned to detect the state of the accelerator 4. The resistor R4 to R15 are functioned to ascend and/or descend the voltage. N1 and N2 enclosed within a broken line of the diagram are two contact points of a relay which is controlled by the brake. When the brake is treaded down, N1 and N2 are broken off, on the other hand, they are closed. Therefore, ensures that the brake lamps and the accelerator lamps are not lightened simultaneously. The brake indicator lamps L1a to L10a are generally in red color. So that the accelerator indicator lamps are better in blue, green and/or any other appropriate colors.

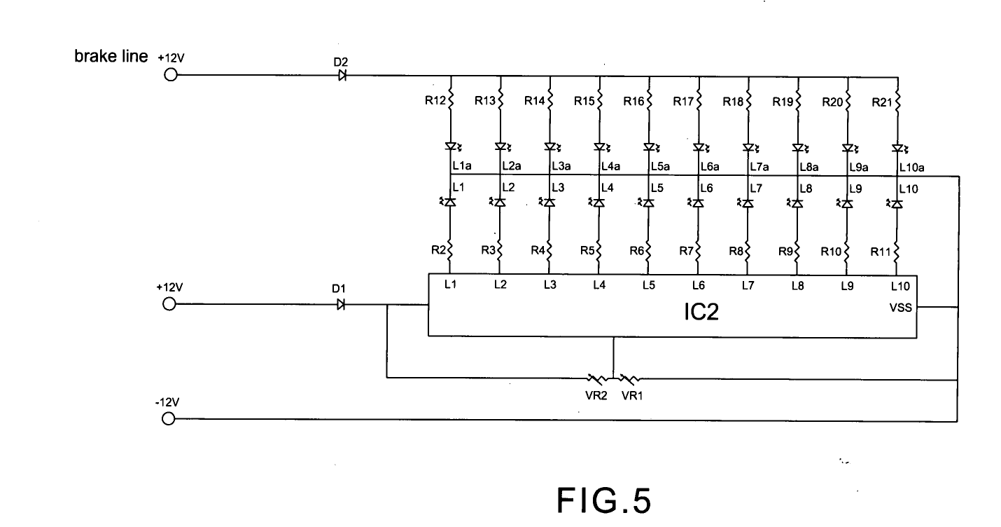

The present invention is not limited on the above arrangement, in FIG. 3, the components and the linking-up wires relevant to the brake system may be omitted so as to achieve an independent accelerator 4 and controller 2. Further, an exclusive pith plate is provided in accordance with the controller circuit in FIG. 3. As shown in FIG. 5, the IC1 and its ambient components Q1, R1, C, R1, R2 in FIG. 3 can be combined together with the IC2.

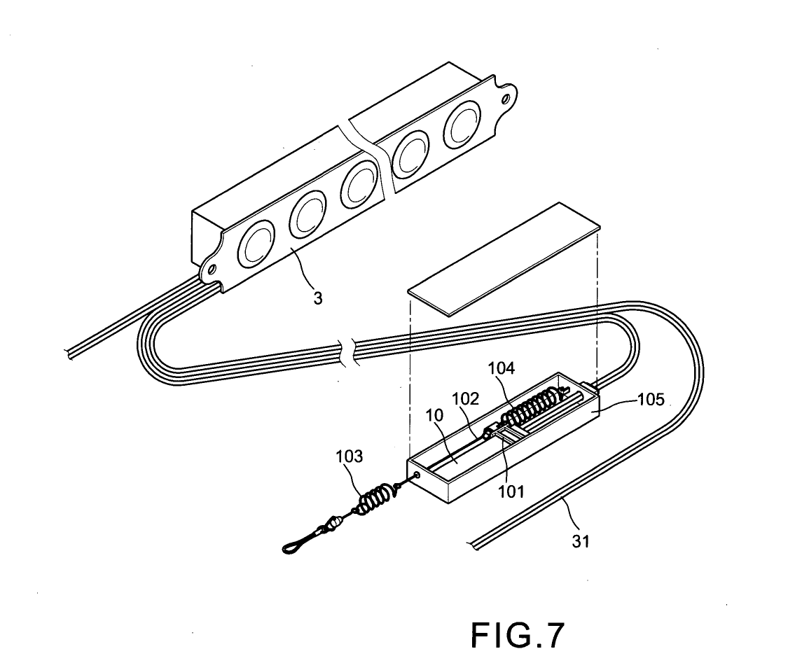

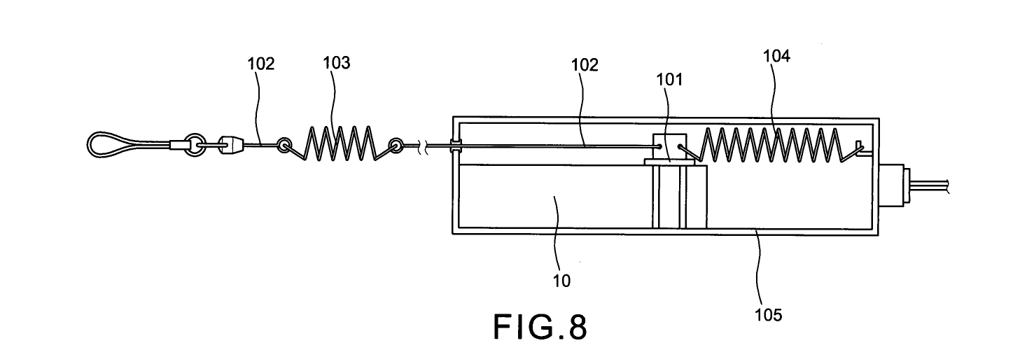

Referring to FIGS. 7 and 8, a concrete structure of the accelerator operational indicating device of the present invention is shown. The variable resister 10 comprises a movable contact point 101 connected to one end of a cord 102, a spring 103 connected to the other end of cord 102, a spring 104 respectively connected to the other side of the movable contact point and an inner wall of a box 105, wherein the spring 103 has a buckle at free end fastened on the treadle of the accelerator 4 (not shown), so that the movable contact point 101 is slidable in the box 105 and moved in concert with the movement of the treadle. A pair of electric wires connects the variable resistor 10 with the indicator 3 in which is the controller 2 (not shown) and a pair of additional electric wires 31 connects the indicator 3 to a brake switch (not shown).

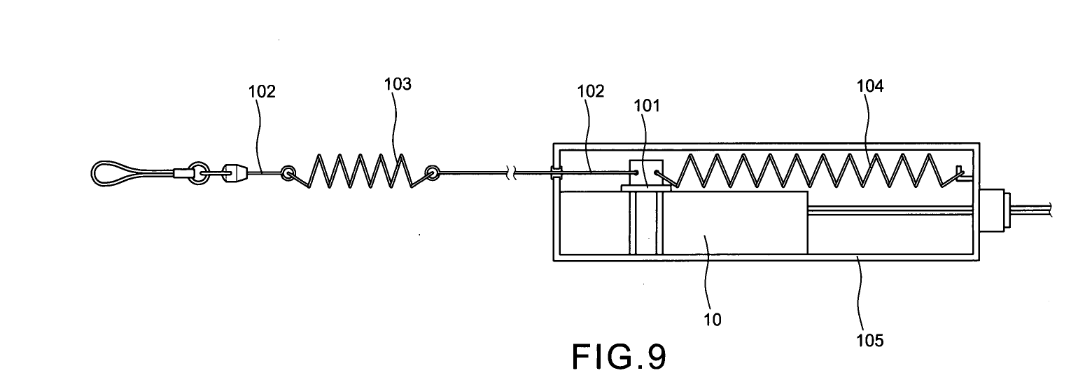

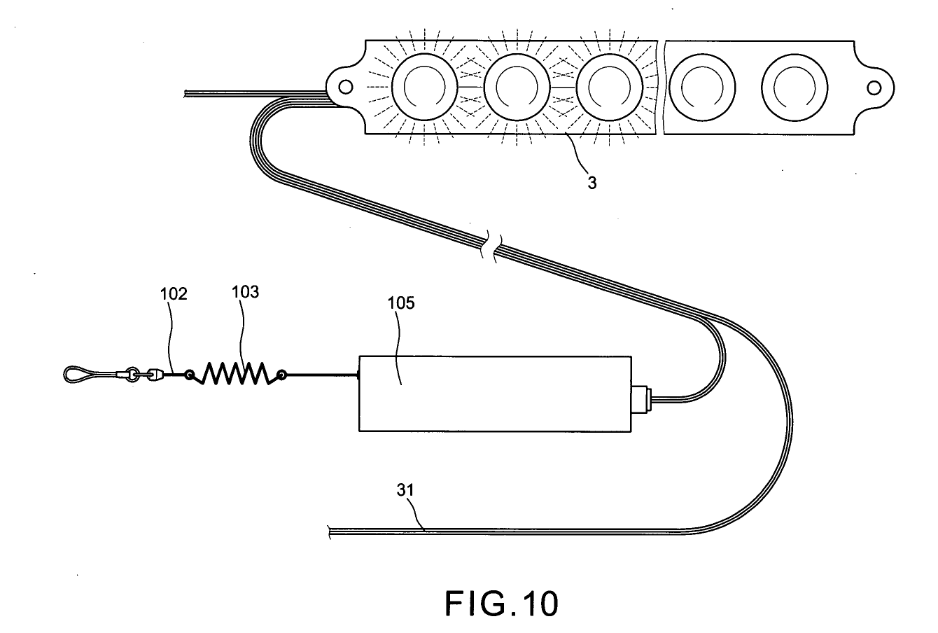

Referring to FIGS. 9 and 10, the indicator 3 has a plurality of luminescent electric diodes (LED) in two colors. When treads the treadle downward, the movable contact point 101 in the variable resistor 10 is actuated through the cord 102 to slide about to convert the voltage large or small so as to lighten or to put out the LED lamps sequentially. When treads down the brake board, the wires 31 transmits the electric current from brake system to connect the +12V brake current (as shown in FIG. 3) to lighten all the lamps L1a to L10a, when the brake board is not treaded down, the brake electric current will not be turned on so that the +12V current voltage also not inputs in, the lamps L1a to L10a are therefore put out. The lamps L1a to L10a shall be lightened or put out simultaneously if the indicator 3 is used in combination with the brake system.

Note that the specification relating to the above embodiment should be construed as an exemplary rather than as a limitative of the present invention, with many variations and modifications being readily attainable by a person of average skill in the art without departing from the spirit or scope thereof as defined by the appended claims and their legal equivalents.

1. An accelerator operational indicating device to reinforce safety for automobiles comprising:
a detector having one end connected to an accelerator and other end connected to an indicator disposed at a predetermined position on a back of said automobile for indicating the movement of said accelerator;
a controller embedded into said indicator and connected said detector through a pair of electric wires for inputting a driving signal to said indicator to sequentially lighten a plurality of LED lamps;
whereby said indicator according to the movement of a treadle of said accelerator to present different lighting state of the LED lamps to warn the driver of a following automobile to timely take correct driving action for preventing an accident of car crash from happened.

2. The accelerator operational indicating device as recited in claim 1, wherein said detector is a variable resistor which has a movable contact point slidably disposed in a box having one end connected to a cord, a first spring and a buckle which can be selectively fastened to the treadle and/or a linking-up wire of said accelerator and an other end connected to a second spring inside said box and a electric wire which positioned between said contact point and said controller inside said indicator.

3. The accelerator operational indicating device as recited in claim 2, said variable resistor may be replaced with an infrared ray sensor, a magnetic sensor, a voltameter, a pressure sensor and/or any relevant components which can be able to transform the varied treadle movement into signals of voltage and/or electric current.

4. The accelerator operational indicating device as recited in claim 1, wherein said indicator is disposed to a predetermined position on the back of an automobile having a plurality of LED lamps spacedly disposed on outer surface and may be arranged into a shape of straight line, an arcuate line, a circle or a triangle.

5. The accelerator operational indicating device as recited in claim 4, wherein said LED lamp of the accelerator may be in blue, green and/or other colors distinguished from the red color of brake indicator lamps.

6. The accelerator operational indicating device as recited in claim 4, wherein each of said LED lamps may be combined with two different colors if said indicator simultaneously connected with said brake through a pair of additional electric wires.

7. The accelerator operational indicating device as recited in claim 6, wherein said LED lamps can be arranged into Arabic numerals if each of said lamps contains seven LED.

8. The accelerator operational indicating device as recited in claim 1, wherein said LED may replaced with other lamps or any luminous means.
